(19) United States
(12) Patent Application Publication
(10) Pub. No.: US 2008/0115807 A1
(43) Pub. Date: May 22, 2008

(54) METHOD FOR EVALUATING AND GUARANTEEING THE THERMAL HYGIENIC EFFECT IN A MULTITANK DISHWASHER

(76) Inventor: Bruno Gaus, Offenburg (DE)

Correspondence Address: Muncy, Geissler, Olds & Lowe, PLLC, P.O. BOX 1364, FAIRFAX, VA, 22038-1364, US

(21) Appl. No.: 11/856,715

(22) Filed: Sep. 17, 2007

Related U.S. Application Data
(63) Continuation of application No. PCT/EP06/02384, filed on Mar. 15, 2006.

(30) Foreign Application Priority Data
Mar. 16, 2005 (DE) DE 102005012086

(51) Int. Cl. B08B 7/04; B08B 9/20; B08B 3/00

(52) U.S. Cl. 134/18; 134/56 D; 134/25.2; 134/61

(57) ABSTRACT

A method for evaluating and guaranteeing a thermal hygienic effect in a conveying dishwashing machine preferably a multi-chamber dishwasher, is provided. The inventive dishwasher is provided with one or several sensors which are fixed therein and transmit a temperature inside each treatment areas to a machine controller, preferably a controller for the conveying dishwashing machine. The machine controller determines the thermal hygienic effect by means of heat equivalent-based temperature and time acting on a cleanable object. A washing process is controlled in such a way that predetermined quantity of heat equivalents is transmitted to the cleanable object.

This nonprovisional application is a continuation of International Application No. PCT/EP2006/002384, which was filed on Mar. 15, 2006, and which claims priority to German Patent Application No. DE 102005012086, which was filed in Germany on Mar. 16, 2005, and which are both herein incorporated by reference.

### BACKGROUND OF THE INVENTION

1. Field of the Invention

The present invention relates to a method for evaluating and guaranteeing the thermal hygienic effect upon wash items in a dishwasher during the cleaning process.

2. Description of the Background Art

In the commercial sector, for the cleaning of wash items, besides single-chamber automatic dishwashers, multitank dishwashers are also nowadays used, in which the items to be cleaned are transported by means of a conveyor through the various zones of the dishwasher. Multitank dishwashers generally comprise at least one rinsing zone, at least one clear-rinsing zone and, optionally, a drying zone. Multitank dishwashers, in which the wash items to be cleaned pass through various treatment zones, are generally constructed as belt transport or as basket transport machines. Common to both versions is the fact that the wash items are transported by the transport means continuously through the individual treatment zones. The individual treatment zones are usually constructed as chambers, comprising openings in the transport direction of the conveyor through which the items to be cleaned are transported by means of the conveyor.

At the commencement of operation of the multitank dishwasher, the rinse water reservoir of the rinsing zone is filled with fresh water and is heated to the preset rinsing tank temperature. In addition, detergent is added to the rinse water. If a plurality of rinsing zones are disposed one behind the other, this applies analogously. Normally the rinsing zone has a rinse water circulating pump, which sucks up rinse water from the rinse water reservoir and sprays it onto the wash items, via a spraying system assigned to the rinsing zone, in order to remove the dirt clinging to the wash items. Then the rinse water flows together with the rinsed-off dirt back into the rinse water reservoir. The rinsed-off dirt is hereupon filtered out of the rinse water by the use of a sieve system.

In the clear-rinsing zone, detergent and dirt residues, which are found loose on the wash items, are rinsed off by means of hot fresh water, which is sprayed with a corresponding spraying system. In many embodiments of multichamber dishwashers, the re-rinse water is collected after first usage in a pump clear-rinse tank and is sprayed by means of a pump and a further spraying system once again over the items to be cleaned. This procedural step is realized prior to the items to be cleaned undergoing a clear-rinse with fresh water. The fresh water or clear-rinse water is then fed in part to the rinse water reservoir so as to dilute the dirt components which are present there in the rinse water reservoir. After this, the items to be cleaned are transported into the following, optionally present drying zone, in which the wash items are dried.

For the cleaning result, the process factors detergent concentration, contact time of the items to be cleaned from the first contact with the rinse water of the first rinsing zone up to their exit from the clear-rinsing zone, the mechanics of the spraying systems or spray jets in the rinsing zones, and the temperatures in the individual rinsing zones are of critical importance. For the process parameters detergent concentration, contact of the wash items to be cleaned with the rinse water of the first rinsing zone up to their exit from the clear-rinsing zone, and mechanics in the rinsing zone, methods for registering said process parameters are known. For instance, the detergent concentration is usually registered via the conductance of the rinse liquid. The contact time is obtained from the transport speed of the conveyor and the wash mechanics are determined via the pressure of the circulating pump and the construction of the nozzles of the spraying system in the respective rinsing zone. The temperature of the rinse water in the individual treatment zones is registered via temperature sensors. As a result of cooling of the rinse water once this has left the spray nozzles of the spraying system, the temperature which is reached on the surface of the items to be cleaned is not identical with the rinse water temperature. For the germ reduction on the surface of the items to be cleaned, specifically this temperature, which is reached on the surface of the items to be cleaned in the individual treatment zones, as well as the time for which these temperatures act upon the items to be cleaned, is of critical importance. The effect of a specific temperature for a specific time upon the surface of the items to be cleaned is or can be referred to as the heat equivalent.

The correlation of temperature and time to the germ reduction forms, inter alia, the basis of regulations and standards which are intended to guarantee the cleaning effect in dishwashers. Based on trials conducted on multitank dishwashers with the aim of defining the process parameters at which a reliable hygienization of the wash items is achieved, with DIN 10510 C.3 for Germany a method has been adopted that defines the minimum requirements with respect to temperature, detergent concentration and length of time between the first contact of the items to be cleaned with the rinse liquid of the first rinsing zone up to their exit from the clear-rinsing zone, for which duration this multichamber rinsing zone must then be operated in the individual process zones in order to achieve the required germ reduction during customer onsite operation. The basis of this standard is the germ reduction of specifically dirtied test bodies, after the cleaning process, by means of so-called surface contact investigations. In this test, E. faecium ATCC 6057 is used as the test germ or organism.

The testing of the hygienic reliability of multitank dishwashers on the premises of the end user is carried out via surface contact investigation and the determination of the germ count in the rinse water of the last rinse tank. A drawback is, however, the fact that the customer on˜site testing of the germ reduction according to this standard can be conducted only with great effort. A further drawback of this standard is the fact that the same germ reduction could be achieved, for example, also with a shorter contact time, yet with higher temperatures in the individual treatment zones. This is not permitted, however, by this standard.

In the USA, the correlation of temperature and time to the germ reduction is described by the NSF3 standard procedure. The basis of this prespecification is the germ reduction of tuberculosis bacteria through the action of a temperature over time, which germ reduction has been determined by trials. The action of the temperature over time is here referred to as the “heat equivalent”. In this procedure, the number of heat equivalents per second obtained at what temperature is recorded in a table. On the basis of this table, for dishwashers, minimum temperatures for the rinse water of the rinsing zone and of the re-rinsing zone are defined, which minimum temperatures the dishwasher must reach in order to achieve the germ reduction required under this standard. For the dishwasher manufacturer, this means that these temperatures must be factory preset fixedly in the control system of the particular dishwasher and that these temperatures must also actually be strictly observed during the customer on-site operation of the dishwasher. In the process testing of a dishwasher according to this method, a temperature sensor is fitted on a plate. The plate is then placed in a predetermined position in the conveyor of the multitank dishwasher and is transported through the individual process zones of the multitank dishwasher. The temperatures during the cleaning process are here recorded. From the temperature pattern during the transport of the wash items through the multitank dishwasher, the heat equivalent acting upon the plate throughout the cleaning process is determined with reference to the abovementioned table. This testing shall be carried out for three different plate positions in a dish basket or a transport basket. For the fulfillment of the required germ reduction, under this regulation at least 3 600 heat equivalents must be reached in each plate position. An advantage with this method is that this method can be carried out on the premises of the customer in order to check the satisfactory working of the multitank dishwasher with respect to thermal hygienization. A further advantage is that the result is on hand immediately after the measurement and thus a statement can immediately be made regarding the quality of the cleaning process.

A drawback with the operation of the dishwasher is, however, the fact that from the temperatures of the rinse water of the individual treatment zones must be deduced the heat equivalents which in the rinsing process act upon the dishes, while those heat equivalents which are actually applied to the wash items are not determined.

In the field of cleaning and disinfection equipment, in prEN ISO 15883-1 a method is described which, in order to evaluate the hygienic effect, likewise makes use of the correlation between germ reduction and temperature over time. This correlation is referred to as the A0 value and is likewise recorded in tabular form or is calculated from a mathematical formula. The Ao value is more closely described in Appendix A of this standard and is defined as the time equivalent in seconds at 80° C. with which a given disinfection effect is exerted and corresponds analogously to the heat equivalents of the NSF3 standard, though on the basis of a different test germ. The test organism used in this method is Enterococcus Faetium. Here too, a minimally required Ao value must be achieved at each point in the rinse chamber of the cleaning/disinfection equipment. To date, however, this method is not yet used for the evaluation of commercial dishwashers in Europe.

The above-described procedures and standards for guaranteeing the cleaning result with respect to thermal hygienization in a multitank dishwasher all have the drawback that the process parameters in the operation of the dishwasher are fixedly predetermined. This applies especially to the temperatures in the rinsing and clear-rinsing zone. If several programs or transport speeds are selectable, the multitank dishwasher must be designed for the worst-case scenario, i.e. in general for the fastest transport speed. The fact that, for the operation of the multitank dishwasher, no process for the heat equivalents actually acting upon the wash items, which process is fixedly installed in said multitank dishwasher and is connected to the control system thereof and controls the rinsing process, is known produces the drawback that the multitank dishwasher, with respect to the heat equivalents, cannot optimally be adapted to the rinsing process or rinsing program which is actually present. A further drawback of the currently known prior art is that the heat equivalents which are actually transferred to the wash items are not registered, but rather it is assumed that the required germ reduction is achieved with the process parameters which have been predetermined according to the standard or procedure.

EP 1 196 650 BI relates to a method for monitoring a washing process. Here, an independent cableless monitoring apparatus is fitted onto a conveyor belt of an industrial dishwasher and is moved with said conveyor belt. The measured data are recorded in a monitoring unit. With this apparatus, the temperatures at the individual rinsing zones could be recorded and then analyzed at a later point. After this, a determination of the heat equivalents transferred to the items to be cleaned could be realized on the basis of the determined temperature values. The difference to the temperature recording according to the procedure of the NSF3 standard consists in the fact that the temperature is registered wirelessly. Similarly to the testing procedure under the NSF3 standard, however, the apparatus known from EP 1 196 650 BI serves merely, with regard to the measured process temperature, to monitor the process temperatures, is not evaluated by the control system of the dishwasher and thus does not serve directly to control the process parameters of the multitank dishwasher.

It can be gathered from DE 19 6 08 03 6 C5 to make the dependency of the re-rinse water quantity upon the transport speed of the conveyor of the multitank dishwasher directly dependent. A dependency of the clear-rinse water quantity, and the heat equivalents actually transferred to the wash items, are not explored in detail under DE 196 08 03 6 C5.

### SUMMARY OF THE INVENTION

It is therefore an object of the present invention to provide The object of the invention is to provide a method for registering the heat equivalents transferred to the items to be cleaned, so as to eliminate the above-represented drawbacks of the solutions according to the prior art and, at the same time, increase the process reliability with respect to the thermal hygienic effect.

Following the inventively proposed solution, on the conveyor of a multitank dishwasher a cableless sensor is fitted, which is transported with the conveyor apparatus, together with the items to be cleaned, through the individual treatment zones of the multitank dishwasher. The conveyor can be configured, for example, as a continuous, revolving conveyor belt. The items to be cleaned can also be housed in transport baskets, which are placed onto a continuous conveyor belt and thereby transport the items to be cleaned through the multitank dishwasher.

As a result of a suitable method for registering the heat equivalents throughout the rinsing process and a feedback to the machine control system of the heat equivalents actually transferred to the wash items, it would be conceivable, for example, at lower transport speeds, to reduce the re-rinse water quantity and hence the energy requirement and, at the same time, nevertheless to transfer the required number of heat equivalents to the items to be cleaned. It would further likewise be conceivable to adjust the transport speed of the conveyor to the temperatures in the rinsing and the clear-rinsing zone, with the aim of likewise transferring the required number of heat equivalents. In concrete terms, at higher rinse water temperatures, for example, a higher transport speed would be possible, with which, in turn, a higher dishwashing capacity is associated. This in turn means that a multitank dishwasher of this type, given the same dishwashing capacity, is shorter in build, thereby becomes less expensive and, moreover, takes up less installation space.

The position of the cableless sensor can advantageously be chosen such that the temperatures measured by the cableless sensor are equal to the temperatures prevailing on the surface of the items to be cleaned. The temperatures which are here determined are permanently transferred to the control system of the multitank dishwasher at the end of a respective treatment zone, for instance at the end of the pre-emptying zone, the rinsing zone, the pump clear-rinsing zone or the fresh water clear-rinsing zone, or at the end of the entire process section of the multitank dishwasher. In the control system, from the measured and stored temperatures, the heat equivalents transferred during the process to the items to be cleaned are calculated and, where necessary, an adjustment of the transport speed or an adjustment of the temperature of the re-rinse water, or a change in other suitable process parameters, is made on the basis of the calculated values for the heat equivalents. An adjustment of the process parameters is here made according to the viewpoint of an optimal or a minimal energy consumption combined with certain achievement of the required heat equivalents in order to meet the prespecifications of standards, such as, for example, the procedure of the NSF3 standard or the procedure, which is currently only applicable to cleaning and disinfection equipment, under prEN ISO 15883-1.

Alternatively, the sensors can be fitted in fixed arrangement in the individual treatment zones of the multitank dishwasher. The positions of the preferably cableless sensors in the individual treatment zones of the multitank dishwasher are chosen such that, here too, the temperatures measured by means of the fixedly installed sensors are guaranteed to be equal to the temperatures prevailing on the surface of the items to be cleaned.

Here too, the measured temperatures are continuously transferred to the control system of the multitank dishwasher. In the control system of the multitank dishwasher, a calculation is made of the heat equivalents transferred during the rinsing process to the items to be cleaned and, if need be, an adjustment is made to the transport speed of the conveyor, or to the temperature of the re-rinse water, or to other suitable process parameters. Here too, the adjustment of the process parameters is made according to the viewpoint of an optimal or minimal energy consumption combined with certain achievement of the required heat equivalents.

One advantage of the inventively proposed method can be seen, above all, in the fact that, where the inventively proposed solution is applied, a multitank dishwasher actively monitors the hygiene of the items to be cleaned and, for example, in the event of irregularities in the rinsing operation, such as, for example, the introduction of items to be cleaned with different thermal capacities and an accompanying change in the energy requirement, or in the event of the introduction of cold water, suitable measures, such as, for example, a reduction of the transport speed of the conveyor, can be compensated by the control system. Furthermore, in the inventively proposed method, during end user on-site operation of the multitank dishwasher, the satisfactory working of the multitank dishwasher with respect to the thermal hygienization can be easily portrayed without, for example, actively introducing into the multitank dishwasher the bacterial strains recorded within the framework of the aforementioned standards.

Moreover, the inventively proposed method allows the hygienic effect during the operation of the multitank dishwasher to be guaranteed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a section of a pass-through automatic dishwasher having a rinsing zone, a pump clear-rinsing zone and a fresh water clear-rinsing zone,

FIG. 2 shows a section of a pass-through automatic dishwasher having sensors respectively assigned to the individual treatment zones, which sensors are fixedly installed.

### DETAILED DESCRIPTION

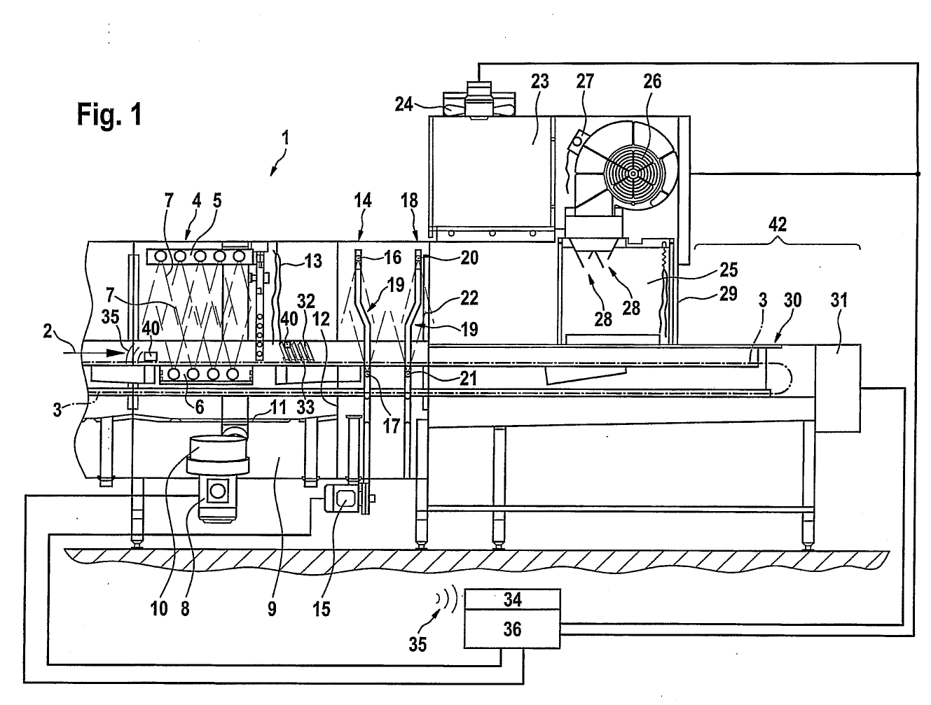

From the representation according to FIG. 1, a pass-through dishwasher 1 can be seen, in which items to be cleaned 32 are transported in the transport direction 2 through various treatment zones of the pass-through dishwasher 1. A conveyor 3, which in the representation according to FIG. 1 is represented as a continuous conveyor belt, transports the items to be cleaned 32 through the various treatment zones of the pass-through dishwasher 1. Viewed in the transport direction 2 of the items to be cleaned 32, these first pass through a rinsing zone 4.

Within the rinsing zone 4 there is located a first rinsing system 5 and a second rinsing system 6. From this, cleaning fluid 7 is discharged in jet form. The first rinsing system 5 and the second rinsing system 6 are supplied with cleaning fluid via a first pump 8.

The first pump 8 is housed within a rinsing zone tank 9 assigned to the rinsing zone 4. In the upper region of the first pump 8 there is located a pump′ housing 10; the rinsing zone tank 9 is covered by means of a tank-covering sieve 11. The rinsing zone tank 9 assigned to the rinsing zone 4 contains a heated or unheated water supply.

The rinsing zone 4 is separated by means of a separating curtain 13 from the—viewed in the transport direction 2 of the items to be cleaned 32—adjoining pump clear-rinsing zone 14. The rinsing zone tank 9 is separated by means of a partition wall 12 from the tank, which is located beneath the pump clear-rinsing zone 14 or the fresh water clear-rinsing zone 18.

In the representation according to FIG. 1, the items to be cleaned 32 leaving the rinsing zone 4, after passing through the separating curtain 13, enter into a pump clear-rinsing zone 14. The pump clear-rinsing zone 14 is fed by a second pump 15. The cleaning fluid 7 discharged from a first spray pipe 16 and a second spray pipe 17 in the pump clear-rinsing zone 14 wets the items to be cleaned 32 from the top side and from the bottom side. The spray pipes 16 and 17 disposed in the pump clear-rinsing zone 14 are accommodated on a bent pipe, so that an offsetting of the first spray pipe 16 relative to the second spray pipe 17 of the pump clear-rinsing zone 14 is achieved.

The same applies to a fresh water clear-rinsing zone 18, which can be placed downstream of the pump clear-rinsing zone 14. The fresh water clear-rinsing zone 18 comprises an upper spray pipe 20 and a lower spray pipe 21. The two spray pipes 20 and 21 are, in accordance with the spray pipe path 19—viewed in the transport direction 2 of the items to be cleaned—likewise disposed in mutually offset arrangement. The fresh water volume discharged from the upper spray pipe 20 and the lower spray pipe 21 wets the items to be cleaned 32 from the top side thereof and the bottom side thereof.

Placed downstream of the fresh water clear-rinsing zone 18 is a heat recovery device 23, which contains a waste-air fan 24 by means of which waste air is extracted from the pass-through dishwasher 1. Adjoining the heat recovery device 23, viewed in the transport direction 2 of the items to be cleaned 32, is a drying zone 25. The drying zone 25 comprises a fan 26, to which a sensor 27 is assigned.

The air leaving the fan 26 is blown via discharge nozzles 28 onto the top side of the items to be cleaned. In the representation according to FIG. 1, the fan 26 is assigned two discharge nozzles 28, which—viewed in the transport direction 2 of the items to be cleaned 32—are arranged lying one behind the other. The drying zone 25 is screened by a further separating curtain 33 from a delivery section 30 of the pass-through dishwasher 1. In the region of the delivery section 30 of the pass-through dishwasher 1 according to the representation in FIG. 1, the dried and partially cooled, now cleaned items 32 can be removed from the conveyor 3 in the form of a conveyor belt. The conveyor 3 in the form of a conveyor belt is driven by a drive mechanism 31, which can be disposed at the end of the delivery section 30. From the representation according to FIG. 1, it can additionally be seen that cableless sensors 40 can be attached to individual holding devices 33 of the conveyor 3. The assembly position of the cableless sensor 40 in the upper region of the holding devices 33 for items to be cleaned 32 serves to ensure that the temperature value which is registered by the sensor 40 and relayed by a signal 35 to a receiving part 34 of the control system 36 corresponds to the temperature exhibited by the items to be cleaned 32 accommodated in the conveyor 3. Alternatively, the cableless sensor 40 for the registration and transmission of the temperature signal 35 can also be accommodated on a transport member of the revolving conveyor 3 in the form preferably of a conveyor belt. According to the embodiment represented in FIG. 1, the cableless sensor 40 is transported with the conveyor 3, together with the items 32 to be cleaned, through the individual treatment zones 4, 14, 18 and 25 of the pass-through dishwasher 1. The temperatures which are here registered can be transferred, either permanently at the end of each individual treatment zone 4, 14, 18, 25 or at the end of the entire process section, to the control system 36. This calculates therefrom the heat equivalents to be transferred during the rinsing process to the items to be cleaned 32, and, where necessary, adjusts, for example, the transport speed of the conveyor 3 in the transport direction 2, the temperature of the clear-rinse water which is applied in the pump clear-rinsing zone 14 or in the fresh water clear-rinsing zone 18 to the items 32 to be cleaned, or other process parameters.

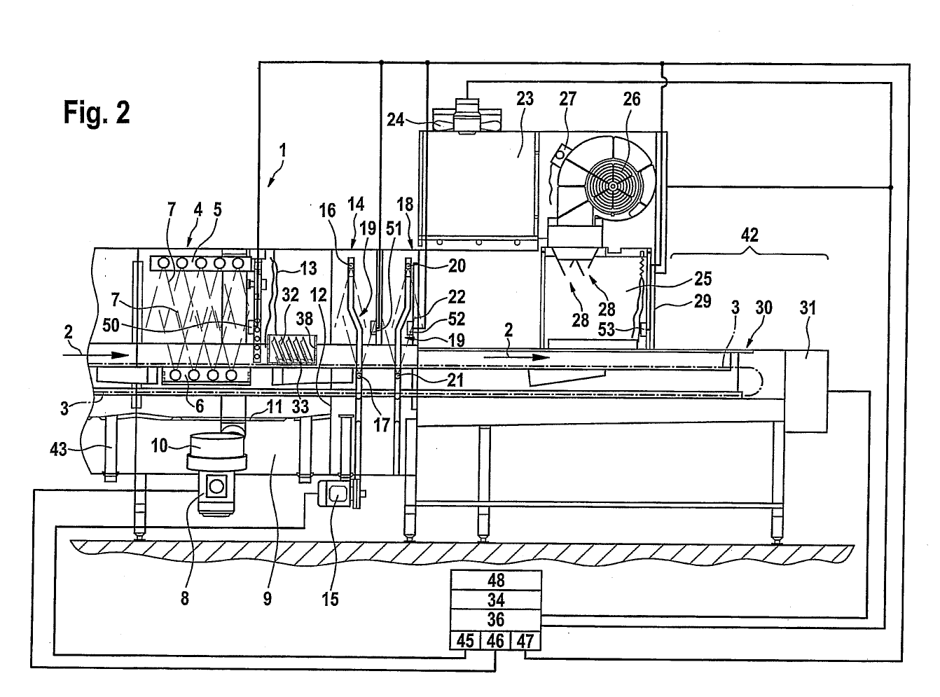

FIG. 2 shows a pass-through dishwasher having fixedly installed sensors respectively assigned to the individual treatment zones.

As a result of the inventively proposed method and the correspondingly configured dishwasher 1, it is possible, where the items to be cleaned 32 are continuously transported through the pass-through dishwasher 1 into its individual treatment zones 4, 14, 18, 25, depending on the process steps which take place there, always to achieve an optimal transport speed of the conveyor 3.

In the various treatment zones 4, 14, 18, 25 of the pass-through dishwasher 1 there are sensors 50, 51, 52, 53, preferably fixedly installed, which are disposed in the various treatment zones. The respective installation positions of the sensors 50, 51, 52, 53 are represented by way of example; according to the miscellaneous framework conditions, the positions of the respective sensors 50, 51, 52, 53 are chosen such that the temperatures determined by these correspond to those temperatures which are respectively exhibited by the items to be cleaned 32 as they pass through the various treatment zones 4, 14, 18, 25 within the pass-through dishwasher 1. The sensors 50, 51, 52 and 53 exchange measurement data with the control system 36 of the pass-through dishwasher 1. The control system 36, which is assigned to the pass-through dishwasher 1, can either be an internal, i.e. disposed within the pass-through dishwasher 1, or else an external, i.e. housed outside the pass-through dishwasher 1, control system 36. The control system 36 comprises a microprocessor (CPU) 45 and a data store 46. Via a main control line, all functions are controlled with respect to the program steps taking place in the pass-through dishwasher 1, i.e. including the process, taking place within the pass-through dishwasher 1, for evaluating the hygienic effect. The control system 36 additionally comprises a measurement data acquisition unit 47, by which the temperature values registered by the at least one fixedly installed sensors 50, 51, 52, 53 are registered and filed in a data store 46. The fixedly installed sensors 50, 51, 52, 53 are connected by the line represented in FIG. 2 to the control system 36, by which the individual process steps of the pass-through dishwasher 1 are controlled.

In addition, the control system 36 controls via an output regulator, which can respectively be placed upstream of the pumps 8 and 15, the electrical energy supply to these latter. Upstream also of the fresh water pump, i.e. the second pump 15, an output regulator can be placed, by which the electrical energy supply to the fresh water pump can be controlled. The same applies to an output regulator by which the energy supply to a heating element for the washing lye can be controlled, and to a further output regulator which controls the energy supply to a heating element in a possibly provided flow heater or boiler for the heating of the clear-rinse water.

In the control system 36, within the data store 46 provided there, the values for the heat equivalents are stored, which either under the NSF3 standard or under the Ao value procedure are critical for determining and classifying the hygienic effect of a pass-through dishwasher 1. In the data store 46 of the control system 36, the below-represented A₀ values according to prEN ISO 15883, which is anticipated in Europe, are able to be stored:

| Tem- | | | | | |
|---|---|---|---|---|---|
| pera- | | | | Ao 3.000 | [symbol] |
| ture | | AufK (see) | A* 600 (sec) | [symbol] | [symbol] |
| | 65^{z} | 1,397.4 | 18,973.7 | 94,868.3 | 1,581.1.1 |
| 1 | 66° | 1,507.1 | 15,071.3 | 75,356.6 | 1,255.9 |
| | 67° | 1,197.2 | 11,971.6 | 59,857.9 | 997.6 |
| [symbol] | 88° | 950.9 | 9,509.4 | 47,546.8 | 792.4 |
| | 69* | 755.4 | 7,353.6 | 37,767.8 | 629.5 [symbol] |
| 1 | 70° | 600.0 | 6,000.0 | 30,000.0 | 500.0 [symbol] |
| | 71° | 476.6 | 4,766.0 | 23,829.8 | 397.2 [symbol] |
| | 72° | 378.6 | 3,785.7 | 18,928.7 | 315.5 [symbol] |
| i | 73° | 300.7 | 3,007.1 | 15,035.6 | 250.6 |
| 1 | 74° | 238.9 | 2,388.6 | 11,143.2 | 1994 [symbol] i |
| | 75^{s} | 189.7 | 1,897.4 | 9,4 [symbol] 6.8 | 1584 [symbol] |
| | 76* | 150.7 | 1,507.1 | 7,535.7 | 125.6 |
| [symbol] | [symbol] | 119.7 | 1,197.2 | 5 [symbol] [symbol] 5 [symbol] | 99.8 |
| i | 78° | 954 | 950.9 | 4,754.7 | 79.2 [symbol] |
| [symbol] | 78° | 75.5 | 755.4 | 3,776.8 | 62.9 |
| | 91 | M | 600.0 | 3,000.0 | 50.0 |
| [symbol] | BV | 47.7 | 476.6 | 2,383.0 | 39.7 |
| i | 82° | 37.9 | 378.6 | 1,892.9 | 31.5 |
| i | S3⁵ | 30.1 | 300.7 | 1,303.6 | 25.1 |
| | 54° | 23.9 | 238.9 | 1,194.3 | 19.9 |
| i | 85* | 19.0 | 189.7 | 948 [symbol] 7 | 15.8 |
| i | 86° | 15.1 | 150.7 | 753.6 | 12.6 |
| i | 87* | 12.0 | 119.7 | 598.6 | 10.0 |
| 1 | 88* | 9.5 | 95.1 | 475.5 | 7.9 |
| [symbol] | 89* | 7.6 | 75.5 | 377.7 | 6.3 |
| [symbol] | 90* | 6.0 | 60.0 | 300.0 | 5.0 |
| [symbol] | 91^{s} | 4.8 | 47.7 | 238.3 | 4 [symbol] 0 [symbol] 1 |
| i | 92* | 3i8 | 37.9 | 189.3 | 3.2 |
| 1 | 93° | 3.0 | 30.4 | 150.4 | 2.5 |
| [symbol] | 94° | 2.4 | 23.9 | 119.4 | 2.0 |
| [symbol] | 95^{c} | 1.9 | 19.0 | 94.9 | 1.6 [symbol] |

[symbol]

indicates data missing or illegible when filed

The AO value which can be gleaned from the above table is defined as the time equivalent in seconds with which a disinfection effect is exerted. The A0 value of a disinfection process with moist heat characterizes the killing of germs, quoted as the time equivalent in seconds at a temperature transferred to the product, e.g. the items to be cleaned 32, by the process.

A fixedly installed sensor 50, 51, 52, 53 which is used in a respective treatment zone 4, 14, 18, 25 of a pass-through dishwasher 1 can be matched to the temperature probe used within the test procedure of the NSF3 standard or that used within the A₀ test procedure; such that, via the control system 36 within the pass-through dishwasher 1, the same heat equivalents as in the procedure of the NSF3 standard or in the A₀ test procedure can be determined. Via the sensors 40; 50, 51, 52, 53 fitted within the respective treatment zones 4, 14, 18, 25 or attached to the continuous conveyor, and via the control system 36, the heat equivalents instantaneously achieved within a program step are determined and compared with the table values filed in the data store 46, for example, in the case of prEN ISO 15883-1, the values deposited there. If the values, determined via the sensors 40; 50, 51, 52, 53, for the heat equivalents achieved within the respective treatment zone 4, 14, 18, 25 of the pass-through dishwasher 1 are too low, then, via the control system 36, either the temperature of the washing lye provided in the washing lye tank can be increased or, via the control system 36, the temperature of the fresh water supplied within the clear-rinsing zone 18 by the clear-rinsing systems 20, 21 disposed there, can be increased. To this end, the corresponding output regulators assigned to the respective pumps 8, 15 are controlled via the control system 36. Furthermore, the possibility exists, via the control system 36, depending on the heat equivalents calculated in the control system 36, of varying the transport speed of the items to be cleaned 32 in the transport direction 2 through the pass-through dishwasher 1. If the values for the heat equivalents, demanded under said standard, are not achieved, then the drive mechanism of the conveyor 3 can be influenced, for example via the control system 36, such that it runs more slowly and thus transports the items to be cleaned 32 at a lower speed through the individual treatment zones of the pass-through dishwasher 1, so that the action time of the heat equivalents is extended, which ultimately helps to secure or raise the temperature acting upon the wash items to be cleaned 32 or those already cleaned.

If the values predetermined under the NSF3 standard, or under prEN ISO 15883-1, for the heat equivalents recorded in the respective treatment zones 4, 14, 18, 25 of the pass-through dishwasher 1 are achieved, then the items to be cleaned 32 are transported into the next, respectively, of the treatment zones 4, 14, 18, 25. The determined values for the heat equivalents can be indicated on a display 48.

A further advantage, which is obtainable with the inventively proposed method, implemented on a pass-through dishwasher 1, for evaluating and guaranteeing the hygienic effect, consists in the fact that the pass-through dishwasher 1 actively monitors the hygiene of the wash items to be cleaned 32. Irregularities in the rinsing operation, such as, for example, the introduction of a larger quantity of cold water into, for example, the rinse-lye tank and of a consequently falling temperature within the rinsing zone 4, can be compensated by suitable countermeasures to be initiated via the control system 36. Thus, via the control system 36, for example, the re-rinse operation, on the one hand, can be extended, or, via an appropriate controlling of an output regulator assigned to the heating element of the washing lye tank, the temperature thereof can be increased so as to counteract the fall in temperature caused by the introduction of cold water. In addition, it is possible—as already discussed above—to vary the transport speed of the conveyor belt through the individual treatment zones 4, 14, 18, 25 of the pass-through dishwasher 1, using those values for the heat equivalents determined in the control system 36 which are based on the temperatures registered by the cableless sensors 40 or by the fixedly installed sensors 50, 51, 52, 53. Using the inventively proposed method, it is possible, in each process step within the pass-through dishwasher 1, depending on irregularities, e.g. resulting from different items to be cleaned 32, with respect to the mass or temperature of the items to be cleaned 32, prior to the commencement of each individual process step, to register the respective achieved heat equivalents and analyze them according to the prespecifications from the NSF3 regulation or the prEN ISO 15883-1 standard and to control the process parameters of the pass-through dishwasher 1 accordingly. The achieved values for the calculated heat equivalents can respectively be indicated via the display 48. The possibility is thus offered to the user of the pass-through dishwasher 1 to track or monitor the thermal hygienic effect during each individual process step.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for evaluating and guaranteeing a thermal hygienic effect in a multitank dishwasher, the method comprising:
providing at least one sensor in the multitank dishwasher, the sensor transmitting a temperature within individual treatment zones to a machine control system, in particular a control system of the multitank dishwasher;
determining, via the control system, the thermal hygienic effect upon the items to be cleaned via the influencing temperature and time on the basis of heat equivalents; and
controlling a rinsing process such that a defined, predetermined quantity of heat equivalents is transferred to the items to be cleaned.

2. The method as claimed in claim 1, wherein the evaluation of the thermal hygienic effect by the machine control system is conducted analogously to the heat equivalents (HUE) of the NSF3 standard regulation.

3. The method as claimed in claim 1, wherein the evaluation of the thermal hygienic effect by the machine control system is conducted analogously to the A₀ values of prEN ISO 15883-1 Appendix A.

4. The method as claimed in claim 1, wherein the transport speed of a conveyor is regulated in such a way via the machine control system that a preset, minimally required value of heat equivalents acting on the items to be cleaned is achieved.

5. The method as claimed in claim 1, wherein a clear-rinse water quantity of a fresh water clear-rinsing zone is regulated in such a way via the machine control system that a preset, minimally required value of heat equivalents acting on the items to be cleaned is achieved.

6. The method as claimed in claim 1, wherein the clear-rinse water quantity is adjustable via a speed-regulated pump.

7. The method as claimed in claim 1, wherein the temperature of the re-rinse water of the clear-rinsing zone is regulated in such a way via the control system that a preset, minimally required value of heat equivalents acting on the items to be cleaned is achieved.

8. The method as claimed in claim 1, wherein during the cleaning process the currently achieved HUE value is indicated to the operator via a display.

9. The method as claimed in claim 1, wherein during the cleaning process the currently achieved A₀ value is indicated to the operator via a display.

10. The method as claimed in claim 1, wherein at least one cableless temperature sensor is transported on the conveyor together with the items to be cleaned through the individual treatment zones of the pass-through dishwasher, and wherein the registered temperature values are transferred to the machine control system either continuously, or following passage through the individual treatment zones or at the end of the process section.

11. A pass-through dishwasher comprising:
at least one conveyor for transporting items to be cleaned through treatment zones and having at least one tank accommodating a cleaning fluid as well as a machine control system for implementing the steps comprising:
providing at least one sensor in the multitank dishwasher, the sensor transmitting a temperature within individual treatment zones to a machine control system, in particular a control system of the multitank dishwasher;
determining, via the control system, the thermal hygienic effect upon the items to be cleaned via the influencing temperature and time on the basis of heat equivalents; and
controlling a rinsing process such that a defined, predetermined quantity of heat equivalents is transferred to the items to be cleaned,
wherein the sensors registering the process temperatures in the individual treatment zones are accommodated either on the conveyor or within the treatment zones of the pass-through dishwasher.

12. The pass-through dishwasher as claimed in claim 11, wherein the sensors are of cableless construction and generate a temperature signal which is transferred to a receiving part of the machine control system.

13. The pass-through dishwasher as claimed in claim 12, wherein the machine control system has a measurement data acquisition unit, in which the temperature signals are stored.

14. The pass-through dishwasher as claimed in claim 11, wherein the at least one sensor is accommodated directly on the at least one conveyor.

15. The pass-through dishwasher as claimed in claim 11, wherein the at least one sensor, viewed in the transport direction of the items to be cleaned, is disposed in the end region of the treatment zones.

16. The pass-through dishwasher as claimed in claim 14, wherein the at least one sensor is accommodated on the at least one conveyor on holding devices for receiving the items to be cleaned.

17. The pass-through dishwasher as claimed in claim 11, wherein the control system has a data store, in which the heat equivalent values under the A₀ value procedure according to prEN ISO 15883-1 Appendix A and/or the SNF3 standard regulation are stored.
